(19) United States
(12) Patent Application Publication
(10) Pub. No.: US 2005/0289319 A1
(43) Pub. Date: Dec. 29, 2005

(54) Memory control apparatus and method for scheduling commands

(75) Inventor: Shin-wook Kang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/088,793

(22) Filed: Mar. 25, 2005

(30) Foreign Application Priority Data
Jun. 24, 2004 (KR) 10-2004-0047623

(51) Int. Cl. G06F 12/00

(52) U.S. Cl. 711/200; 365/189.01

(57) ABSTRACT

Provided are a memory control apparatus and method for controlling an order of processing memory access commands from a plurality of master devices when the master devices access a memory to improve a processing speed. The memory controller includes a command queue receiving memory access commands from at least one master device and storing the memory access commands; a determination unit analyzing addresses of a memory, which will be accessed by the received commands, to control an order of processing the stored commands; and a command interpreter interpreting a command output under the control of the determination unit to output an address related signal. Accordingly, a command processing speed is remarkably improved without increasing a system size.

This application claims the priority of Korean Patent Application No. 2004-47623, filed on Jun. 24, 2004, in the Korean Intellectual Property Office, the disclosure of which is incorporated herein in its entirety by reference.

### BACKGROUND OF THE INVENTION

1. Field of the Invention

The present invention relates to command processing and, more particularly, to a memory control apparatus and method for controlling an order of processing memory access commands from a plurality of master devices when the master devices access a memory to improve a command processing speed.

2. Description of the Related Art

In a system including a processor, command codes executed by the processor are generally stored in a memory and the processor is operated based on the order of interpreting the command codes. The processor that executes commands and accesses the memory is called a master device. A single system can include a plurality of master devices depending on the circumstances. Recently, a system is constructed on a single chip, which is called a system on chip (SOC). The SOC can also include multiple master devices.

The plurality of master devices execute commands independently and thus a plurality of command codes respectively access a memory. Accordingly, it is necessary to control an order of processing multiple memory access commands. A device carrying out the function of controlling the order of processing the memory access commands is called a command scheduler. The command scheduler analyzes the currently processed memory access command and controls the command processing order. The command scheduler is located in a bus controller not in a memory controller.

However, the structure of the bus controller becomes complicated and its processing speed is decreased because the command scheduler judges whether the command processing order is changed or not even when master devices access the same memory region, which does not occur frequently.

### SUMMARY OF THE INVENTION

The present invention provides a memory control apparatus and method for controlling an order of processing memory access commands based on addresses of memory regions accessed by the commands to increase a memory access speed.

According to an aspect of the present invention, there is provided a memory controller comprising a command queue receiving memory access commands from at least one master device and storing the memory access commands; a determination unit analyzing addresses of a memory, which will be accessed by the received commands, to control an order of processing the stored commands; and a command interpreter interpreting a command output under the control of the determination unit to output an address related signal.

Preferably, but not necessarily, the memory accessed by the master device is a DRAM. The command interpreter comprises a RAS (Row Address Strobe) processor generating a RAS signal of the DRAM, and a CAS (Column Address Probe) processor generating a CAS signal of the DRAM.

Preferably, but not necessarily, the determination unit decides the order of processing the commands stored in the memory access command queue such that a memory access command for accessing the same page of the same bank of the memory, which is accessed by the memory access command currently processed by the command interpreter, is processed first.

According to another aspect of the present invention, there is provided a memory control method comprising receiving memory access commands from at least one master device and storing the memory access commands; analyzing addresses of a memory, which will be accessed by the received commands, to control an order of processing the stored commands; and interpreting a command output based on the controlled order to output an address related signal.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a system on chip including a plurality of master devices;

FIG. 2 is a timing diagram of signals required for accessing a DRAM;

FIG. 3 illustrates data output from a DRAM memory cell in response to a memory access signal shown in FIG. 2;

FIG. 4 illustrates an operation of changing the order of processing commands from master devices by a memory controller according to an exemplary embodiment of the present invention;

FIG. 5 is a block diagram of the memory controller according to an exemplary embodiment of the present invention;

FIG. 6 illustrates the structure of a memory including a plurality of banks;

FIG. 7 is a state diagram showing the generation of a RAS signal;

FIG. 8 is a state diagram showing the generation of a CAS signal; and

FIG. 9 is a flow chart of a memory control method according to an exemplary the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

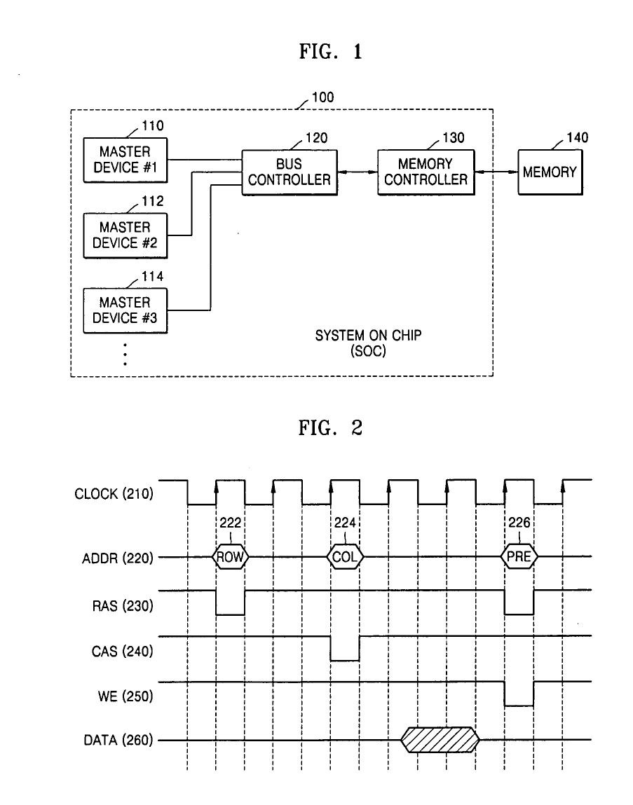

FIG. 1 is a block diagram of a system on chip (SOC) 100 including a plurality of master devices. Referring to FIG. 1, the SOC 100 includes a plurality of master devices 110, 112 and 114. A master device is a kind of processor that reads a command stored in a memory and executes the command. For example, a central processing unit, a video/graphic processor, an audio processor or a network processor can be a master device.

Memory access commands from the master devices 110, 112 and 114 are transmitted to a bus controller 120. The bus controller 120 controls an order of processing the memory access commands from the plurality of master devices 110, 112 and 114. The bus controller 120 includes a bus arbiter and a command scheduler.

A memory controller 130 sequentially processes the memory access commands transmitted from the bus controller 120 to generate signals required for accessing a memory 140. The signals include a RAS (Row Address Strobe) signal and a CAS (Column Address Strobe) signal when the memory 140 is a DRAM. The memory controller 130 can be located outside the SOC 100. A case where the memory 140 is a DRAM will now be explained.

FIG. 2 is a timing diagram of signals required for accessing the DRAM. To access the DRAM, a clock signal 210, an address signal 220, a RAS signal 230, a CAS signal 240, and a WE signal 250 are required. An address value 222 output when the RAS signal 230 is at a low level is a row address that means the row address of the DRAM. When the RAS signal 230 becomes a low level, data of the row corresponding to the row address that is the address value 222 is read and copied to a sense amplifier. When the CAS signal 240 becomes a low level, data 260 corresponding to a column address that is an address value 224 when the CAS signal 240 is at a low level is output. In the case of burst mode, a predetermined number of data items are output for each pulse of the clock signal 210. Then, the WE signal 250 is converted to a low level to carry out precharge. Here, the precharge means that the data copied to the sense amplifier is copied to a corresponding row of the DRAM again.

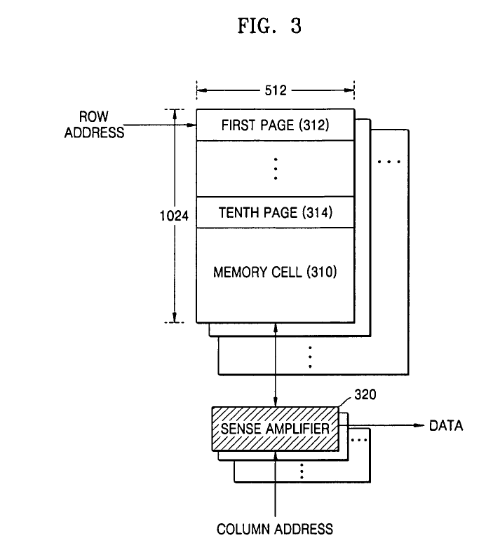

FIG. 3 illustrates data output from a DRAM memory cell in response to a memory access signal shown in FIG. 2.

Assume that a single memory cell 310 includes 512 capacitors in the horizontal direction and 1024 capacitors in the vertical direction. Here, a single capacitor stores 1-bit data. The unit constructed of 512 capacitors is called a page. The page is selected by a row address. In general, 16 memory cells construct a single bank. When 16 memory cells are used, 16-bit data is generated. Thus, a single page includes 512 16-bit data items. Depending on the circumstances, the memory cell can include 1024 or 2048 capacitors in the horizontal direction. In this case, a single page corresponds to 2K bytes or 4K bytes.

An operation of outputting data disposed at a position accessed by a processor will now be explained.

When the first command of the processor is a command for accessing the first row of the memory, 512-byte data of the first page 312 is input to a sense amplifier 320 according to a row address. There are 16 sense amplifiers and thus 512-byte data of another page selected by the row address can be recorded. Then, one of the data items stored in the sense amplifier 320 is selected by a column address and output. In the case of burst mode, a predetermined number of data items are output from the sense amplifier. The sense amplifier is constructed of an SRAM in general. When a precharge signal is applied, the data recorded in the sense amplifier 320 is copied to the first page 312.

When the processor accesses the tenth page 314, data items of the tenth page 314 are selected by the row address and copied to the sense amplifier 320. Then, data corresponding to a single column is selected by the column address. In this manner, addresses of the DRAM are accessed such that corresponding data is output.

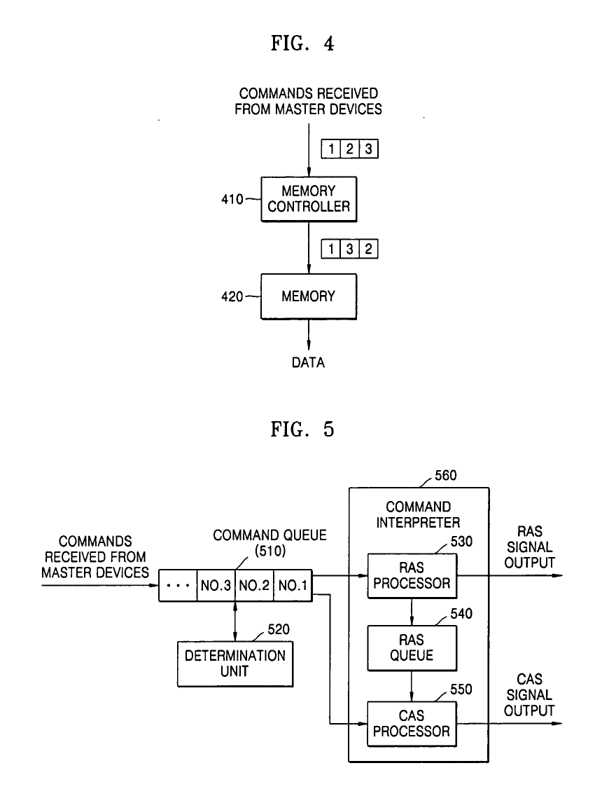

FIG. 4 illustrates an operation of changing the order of processing commands from master devices by the memory controller according to the present invention.

A plurality of commands are input from master devices to the memory controller 410. Assume that the memory controller receives three commands of a first command for accessing data of the first column of the first page of a memory 420, a second command for accessing data of the first column of the tenth page of the memory 420 and a third command for accessing data of the fifth column of the first page of the memory 420. In addition, assume that the memory 420 is operated in the burst mode and the number of data items output as a burst is set to 4.

When the three commands are processed in the order of inputting the commands, time is consumed unnecessarily because the commands are processed in the order of input of the commands unconditionally although the first and third commands access the same page of the memory. If the first command is executed and then the third command is executed immediately, there is no need to generate a RAS signal for the third command and only a CAS signal is required to be generated, which remarkably increases a processing speed.

Accordingly, the memory controller 410 of the present invention directly decides the order of processing the commands. That is, though the commands are input from the master devices in the order of 1, 2 and 3, the memory controller 410 decides the command processing order as 1, 3 and 2 when the memory controller 410 judges that the commands 1 and 3 access adjacent positions of the memory 420.

FIG. 5 is a block diagram of the memory controller according to the present invention. The memory controller includes a command queue 510, a determination unit 520 and a command interpreter 560. The command interpreter 560 includes a RAS processor 530, a RAS queue 540 and a CAS processor 550.

Commands input from master devices are sequentially stored in the command queue 510. Here, assume that the commands are input from the master devices in the order of 1, 2 and 3. When the first command is input to the RAS processor 530, the RAS processor 530 generates a RAS signal that decides a row address of a memory to be accessed and outputs the RAS signal. Then, the first command is transmitted to the RAS queue 540. The CAS processor 550 interprets the first command stored in the RAS queue 540 to generate a CAS signal that decides a column address of the memory to be accessed and outputs the CAS signal. As described above, the RAS signal is generated and then the CAS signal is generated.

The CAS processor 550 executes precharge of the first command and then processes the next command. However, the CAS processor 550 does not process the second command next, but processes the third command before processing the second command when the first and third commands access the same page of the memory. This is determined by the determination unit 520. In this case, the RAS signal for the third command is not generated and only the CAS signal is generated again for the third command since the first and second commands have the same row address.

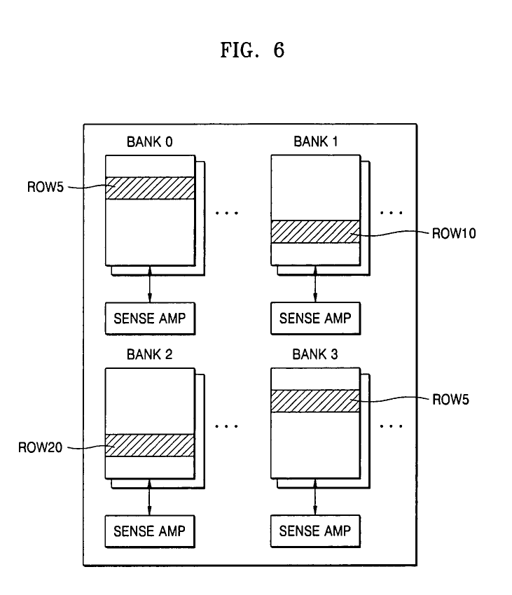

FIG. 6 illustrates the structure of a memory including a plurality of banks. In FIG. 6, the memory includes four banks. The banks are operated independently. For example, the tenth row of a page of bank 1 can be accessed while the fifth row of a page of bank 0 is accessed.

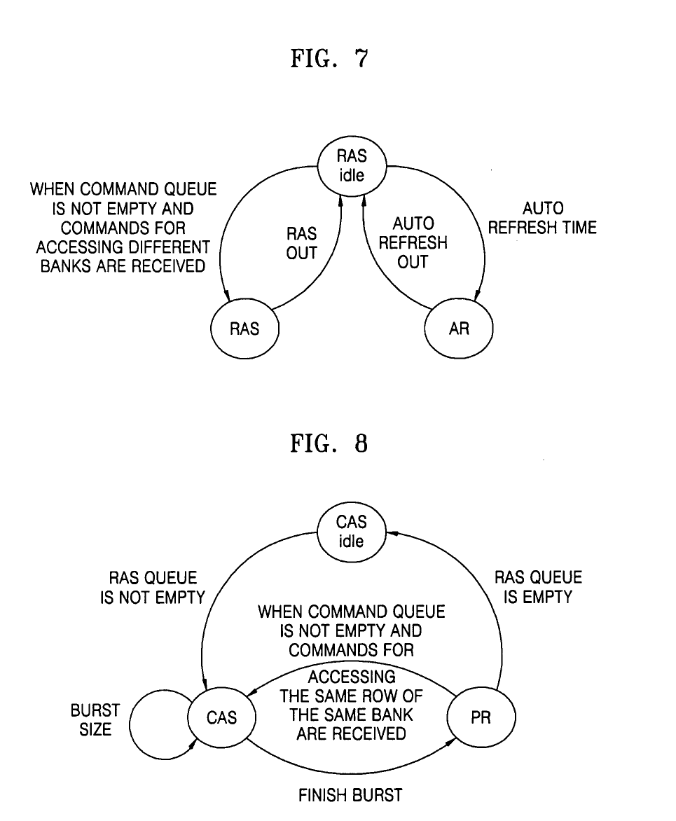

FIG. 7 is a state diagram showing the generation of a RAS signal.

When the command queue is not empty and commands for accessing different banks of the memory to be accessed are input in a RAS idle state, the command stored in the command queue is interpreted to generate a RAS signal, the state returns to the RAS idle state. At auto refresh time, an auto refresh signal is generated in an AR state and outputted.

FIG. 8 is a state diagram showing the generation of CAS signal.

When the RAS queue is not empty in a CAS idle state, a command is interpreted to generate a CAS signal. In the case of burst mode, a precharge signal is generated after the number of output data items, that is, the number of pulses of a clock signal corresponding to a burst size. After the burst mode, the state is changed to a PR state in order to generate a precharge signal. When the RAS queue is empty in the PR state, precharge is executed and then the state returns to the CAS idle state. When the command stored in the command queue and previous command access data of the same row address of the same bank, the CAS signal is generated again and outputted.

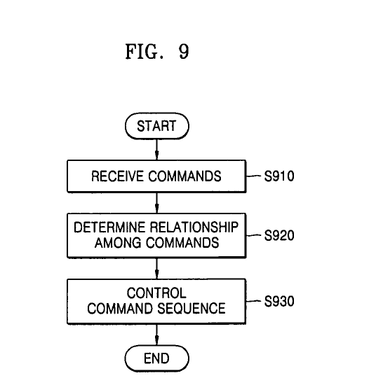

FIG. 9 is a flow chart of a memory control method according to an embodiment of the present invention.

A plurality of commands are received from a plurality of master devices in the step S910. Similarity of memory access positions to be accessed by the received commands is determined in the step S920. That is, it is determined whether the first command and a following command access the same bank and the same row address of a memory. The determination method is shown in FIG. 4. Then, an order of executing the commands is controlled in the step S930.

While the present invention has been particularly shown and described with reference to exemplary embodiments thereof, it will be understood by those of ordinary skill in the art that various changes in form and details may be made therein without departing from the spirit and scope of the present invention as defined by the following claims.

According to the present invention, the order of processing commands from master devices is controlled such that a command for accessing the same position of a memory, which is accessed by the currently executed command, is processed first. Accordingly, a command processing speed can be improved without increasing the system size.

1. A memory controller comprising:
a command queue receiving memory access commands from at least one master device and storing the memory access commands;
a determination unit analyzing addresses of a memory, which will be accessed by the received commands, to control an order of processing the stored commands; and
a command interpreter interpreting a command output under the control of the determination unit to output an address related signal.

2. The memory controller as claimed in claim 1, wherein the memory accessed by the master device is a DRAM.

3. The memory controller as claimed in claim 2, wherein the command interpreter comprises:
a RAS (Row Address Strobe) processor generating a RAS signal of the DRAM; and
a CAS (Column Address Strobe) processor generating a CAS signal of the DRAM.

4. The memory controller as claimed in claim 2, wherein the determination unit decides the order of processing the commands stored in the command queue such that a memory access command for accessing a same page of a same bank of the memory, which is accessed by the memory access command currently processed by the command interpreter, is processed first.

5. A memory control method comprising:
(a) receiving memory access commands from at least one master device and storing the memory access commands;
(b) analyzing addresses of a memory, which will be accessed by the received commands, to control an order of processing the stored commands; and
(c) interpreting a command output based on the controlled order to output an address related signal.

6. The memory control method as claimed in claim 5, wherein the memory accessed by the master device is a DRAM.

7. The memory control method as claimed in claim 6, wherein operation (b) decides the order of processing the stored commands such that a memory access command for accessing a same page of a same bank of the memory, which is accessed by a currently processed memory access command, is processed first.

8. The memory control method as claimed in claim 6, wherein operation (c) comprises:
generating a RAS (Row Address Strobe) signal of the DRAM; and
generating a CAS (Column Address Strobe) signal of the DRAM.
